(19) United States
(12) Patent Application Publication
(10) Pub. No.: US 2007/0113244 A1
(43) Pub. Date: May 17, 2007

(54) System and method for generating an advertising schedule

(76) Inventors: Benjamin Thomas Verschueren, Niskayuna, NY (US); Michael Andrew Woellmer, Troy, NY (US); Stephen John Angelovich, Yonkers, NY (US); David Bret Rabinowitz, Huntington, NY (US); Sara Dawn Doraski, Waldwick, NJ (US); Monique Ann Roy, Mississauga (CA)

Correspondence Address: Patrick S. Yoder;FLETCHER YODER, P.O. Box 692289, Houston, TX, 77269-2289, US

(21) Appl. No.: 11/273,770

(22) Filed: Nov. 14, 2005

(51) Int. Cl. H04N 7/10; H04N 7/025; G06F 13/00; H04N 5/445; G06F 3/00

(52) U.S. Cl. 725/35; 725/34; 725/42

(57) ABSTRACT

A system for generating an advertising schedule is provided. The system comprises a data source and one or more computers connected to the data source. The computers are configured to execute one or more applications related to the generation of an advertising schedule. The system further comprises a network connecting the one or more computers and the data source. The one or more applications are executed on the one or more computers and interact with the data source to automatically generate the advertising schedule based on an inventory of available advertising slots characterized by a projected audience and one or more scheduling criteria for each advertisement to be scheduled.

### BACKGROUND

The invention relates generally to schedule management and, more particularly, to a system and method for generating an advertising schedule for use in one or more advertising mediums.

Many media companies in television, radio, print and the Internet generate revenues through advertising. The demand for advertising on television, radio, print or the Internet can be quite high because each type of media enables an advertiser to broadcast commercial messages to targeted audiences. Accordingly, a media company's allotted time or space for advertising can sell out quite rapidly. For instance, in television, some television networks can sell about 60%-80% of their prime advertising time, also known as billable content or billable time slots, for a year in a short two to three week period. The rest of the billable content is typically sold during the rest of the year on a quarterly basis.

A current approach to selling billable content is based on predicting the show's ratings, measured in terms of viewership ratings, before the airing of a particular show. Based on these predictions, a contract is formed between the broadcast network and an advertiser. The contract generally outlines the terms and conditions including the cost to the advertiser and expectations for the total viewership units to be provided by the broadcast network. These contracts are used to schedule the billable content for the shows, with a goal being to fulfill each contract by the end of the contractual term.

A number of outcomes typically determine the fulfillment of each contract from the perspective of the broadcast network. The scheduled advertising slots may exactly meet the ratings prediction, which means that the cost was optimal and the advertiser's expectations were met. The scheduled advertising slots may not perform satisfactorily in which case the network may have to allocate additional advertising slots in order to fulfill the contract. The scheduled advertising slots may even outperform the ratings prediction, in which case, the network could have charged more for the advertising slots, and has lost potential income. Finally, the contract may not even be met due to a lack of availability of advertising slots, which is not a desirable outcome.

Traditionally broadcasting systems have been built around “function driven processes”. That is, each process within the broadcast system is tailored to meet the specific requirements associated with the functionality of a subsystem of the broadcast system. Function driven processes may include, for example, research, sales, traffic, on-air operations, and so forth. The research function may be associated with a research subsystem that determines projections regarding the viewership of a particular show and measures trends or changes in demographics and ratings. Similarly, the sales function may be associated with a sales planning subsystem that establishes the brand placement in a particular show as a function of the ratings and the contract information. The traffic function may be associated with a traffic subsystem that generates an advertisement schedule based upon expected ratings and contractual obligations.

The availability of information within the above subsystems is distributed among a number of functions and throughout different stages of the broadcast process. In addition, the function driven processes mentioned above, are domain specific and may not function in an integrated fashion. Optimization is generally possible only within a particular functional group rather than across the broadcast system as a whole, leading to a limited ability to efficiently plan, manage and place billable content within a broadcast schedule. This may result in a partitioning and isolation of information between the different function driven processes that comprise the broadcast system and may require manual intervention to enable a smooth process flow between the subsystems of such a system.

For an efficient operation of a broadcast network, an integration of the different functions that comprise the broadcast network is therefore desirable. In addition, there is a need for a method and system for enabling the optimal placement of billable advertising slots within a broadcast schedule, by integrating the functionality of the different processes within the broadcast system in an efficient and timely manner.

### BRIEF DESCRIPTION

Embodiments of the present invention address this and other needs. In one embodiment, a method for generating an advertising schedule is provided. The method comprises automatically generating an advertisement schedule based on an inventory of available advertising slots characterized by a projected audience and one or more scheduling criteria for each advertisement to be scheduled.

In a second embodiment, a system for generating an advertising schedule is provided. The system comprises a data source and one or more computers connected to the data source. The computers are configured to execute one or more applications related to the generation of an advertising schedule. The system further comprises a network connecting the one or more computers and the data source. The one or more applications are executed on the one or more computers and interact with the data source to automatically generate the advertising schedule based on an inventory of available advertising slots characterized by a projected audience and one or more scheduling criteria for each advertisement to be scheduled.

In a third embodiment, a method for generating an advertising schedule is provided. The method comprises determining at least one of a viewing trend, an advertising rate or projected ratings for programming content to be delivered. Then, the method comprises determining one or more scheduling criteria for one or more advertisements to be scheduled based on the viewing trend, the advertising rate or the projected ratings. Finally, the method comprises automatically generating an advertising schedule based on the one or more scheduling criteria, an inventory of available advertising slots and/or the projected ratings.

### DRAWINGS

These and other features, aspects, and advantages of the present invention will become better understood when the following detailed description is read with reference to the accompanying drawings in which like characters represent like parts throughout the drawings, wherein:

FIG. 1 is an exemplary illustration of a system for generating an advertising schedule in accordance with embodiments of the invention; and

FIG. 2 is a flowchart of exemplary logic including exemplary steps for automatically generating an advertising schedule in accordance with embodiments of the invention.

### DETAILED DESCRIPTION

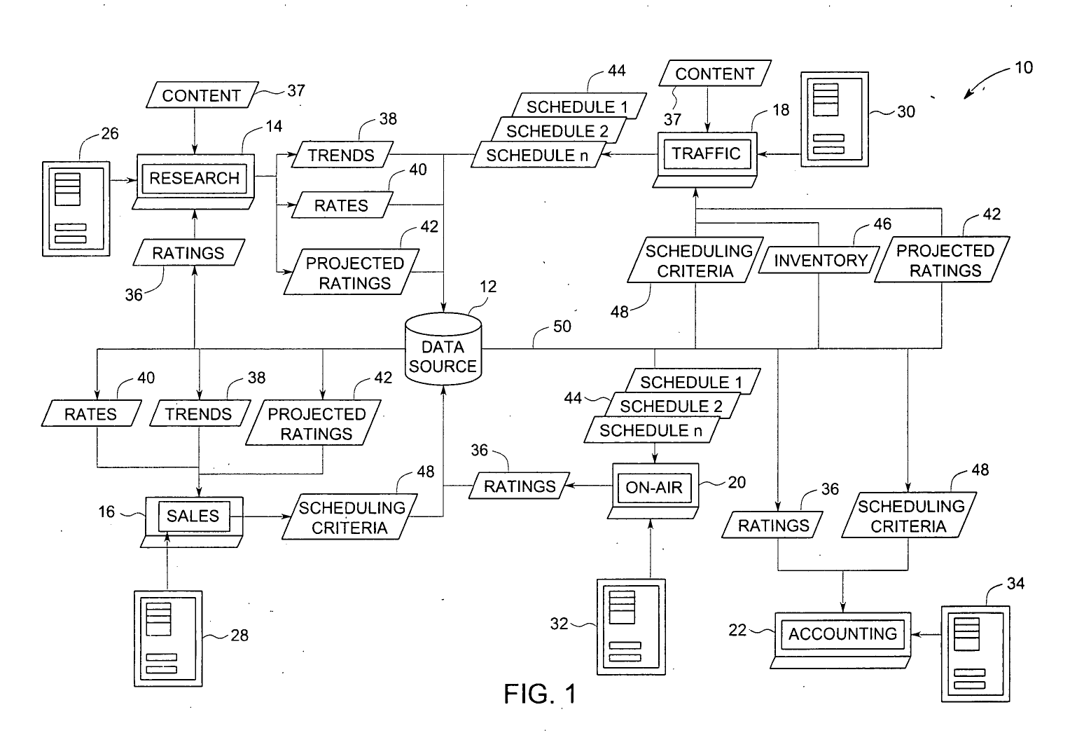

FIG. 1 is an exemplary illustration of a system for generating an advertising schedule in accordance with embodiments of the invention. In accordance with one embodiment, and as will be described in greater detail below, the system 10 is configured to automatically generate an advertisement schedule by integrating one or more diverse information sources associated with different broadcast functions. While the integration and use of such diverse, cross-function information to automatically generate a schedule is one possibility, other cross-functionality applications, such as research, sales, accounting and so forth, may also benefit from the present technique. Therefore, though the automatic generation of an advertising schedule using the present data integration techniques is one example discussed herein, one of ordinary skill in the art will appreciate that other applications utilizing data associated with different functions are contemplated and may be developed in accordance with the present technique.

In accordance with a further aspect of the invention, and as will be described in greater detail below, the system 10 for generating an advertising schedule is based on an inventory of available advertising slots characterized by a projected audience and one or more scheduling criteria for each advertisement to be scheduled. The inventory of available advertising slots may be present on one or more broadcast networks and/or one or more broadcast mediums (such as television, radio, the Internet, and so forth). As used herein, the term “inventory” refers to a list of available advertising slots within a broadcast schedule, in which billable content or commercials are aired. Further, the projected audience may include television viewers, radio listeners and Internet users and the scheduling criteria are generated based on a desired number of audience members having one or more desired demographic attributes.

Referring to FIG. 1, the system 10 generally includes a data source 12, one or more computers 26, 28, 30, 32 and 34 connected to the data source 12 and a network 50 connecting the computers and the data source 12. In accordance with the illustrated embodiment, the computers 26, 28, 30, 32 and 34 may include personal computers, workstations, servers, mainframes, or any other suitable processor-based system. Further, the computers 26, 28, 30, 32 and 34 are configured to execute one or more applications related to the generation of the advertising schedule. The applications may include one or more function driven processes, such as research, sales, traffic, on-air operations and accounting, that contribute to the generation of an advertisement schedule within the system 10. In one embodiment, and as shown in FIG. 1, the applications comprise a research application 14, a sales application 16, a traffic application 18, an on-air application 20 and an accounting application 22.

In accordance with an exemplary operation of the system 10, the research application 14 determines performance projections for one or more shows that comprise the aired programming content within the broadcast schedule, in terms of the number of viewers delivered for each show. In particular, and as shown in FIG. 1, the research application 14 determines viewing trends 38, advertising rates 40 and projected ratings 42 based on a set of show ratings 36 associated with the aired programming content 37. The programming content 37 may include television shows, radio shows, Internet web pages, or other forms of non-advertisement or primary content which an audience seeks out. The viewing trends 38 are determined based on the number of audience members having one or more desired demographic attributes that have watched each airing of a particular show associated with the aired programming content over a period of time when such information is available. The viewing trends 38 may also be determined based upon other viewership predictors, such as focus group or other research results, statistical models based on similar shows and/or on time and day variables, reviews and press coverage, and so forth. The advertising rate 40 is the rate specified by an advertiser for a set of advertising slots over a specified duration of time. The projected ratings 42 for a show are determined based on the number of audience members having one or more desired demographic attributes that are expected to watch each airing of a particular show during a broadcast period. The projected ratings 42 for a particular show may also be determined based on several factors, such as, for example, a set of historical ratings 36 for a particular show, the competing shows on other networks, the performance of the adjacent shows in the program schedule and the historical viewing trends 38 for each show associated with the aired programming content.

The sales application 16 sells advertisement space to advertisers, based on a negotiated delivery for a set of viewers at a specified rate. In a particular embodiment, the sales application 16 determines a set of scheduling criteria (often in the form of contract terms) for each advertisement to be scheduled based on the viewing trends 38, the advertising rates 40 and the projected ratings 42 determined by the research application 14. The scheduling criteria 48 may include a set of advertising slots requested by an advertiser at a specified rate over a specified duration of time. The scheduling criteria 48 may also include a set of terms and conditions, such as, for example, the cost of allocating a set of advertising slots requested by the advertiser at the specified rate, the available number of advertising slots for sale and the expectations for the total viewership units for aired programming content within the broadcast schedule.

The traffic application 18 determines the placement of advertisements within the shows that comprise the broadcast schedule. The traffic application 18 automatically generates the advertising schedule based on information generated by other functional groups. For example, in an exemplary embodiment, the scheduling criteria 48 (generated by the sales application 16), the inventory of available advertising slots 46, the projected ratings 42 (generated by the research application 14) and the programming content 37 may be utilized by the traffic application 18 to generate a schedule 44 which fulfills the scheduling criteria 48 in view of the other information. In an alternate embodiment, and as shown in FIG. 1, the traffic application 18 may generate multiple advertising schedules (44a-44n) for multiple broadcast networks, such as, for example, different television, radio, and Internet channels, networks or media.

A number of optimization algorithms may be used by the traffic application 18 to determine the placement of advertisements within the shows that comprise the broadcast schedule. Example of optimization algorithms that may be used by the traffic application 18 can be found in co-pending U.S. patent application Ser. No. 10/418,494 entitled “METHODS AND APPARATUS FOR SCHEDULING BROADCAST COMMERCIAL VIDEOTAPES”, filed on Apr. 18, 2003 and co-pending U.S. patent application Ser. No. 10/389,303 entitled “METHODS AND APPARATIS FOR SCHEDULING BROADCAST COMMERCIALS”, filed on Mar. 14, 2003, both of which are assigned to the assignee of the present application and both of which are hereby incorporated by reference in their entirety.

The system 10 further comprises an on-air application 20 configured to broadcast the generated advertisement schedule 44 in conjunction with the program schedule. In one embodiment, the on-air application may broadcast the advertisement schedules (44a-44n) to multiple broadcast networks. As will be appreciated by those of ordinary skill in the art, the ratings 36 generated by airing the schedule 44 may be provided to other functional groups, such as the research group, to perform their respective functions. An accounting application 22 may also be present and may compare the actual ratings 36 with the scheduling criteria 48 to determine the status of any given contract as fulfilled or unfulfilled. This information may be used to optimize the fulfillment of the scheduling criteria and maximize the revenue generated.

Furthermore, as will be appreciated by those of ordinary skill in the art, data integration and/or centralization as described herein facilitates the feedback and updating of commonly owned, used, or shared information. For example, such integration allows for feedback within the system 10 that enables the update of information as new information (such as, new or updated contracts, new or updated inventory, or updated ratings) becomes available to the various functional groups. In one embodiment, and as shown in FIG. 1, the data source 12 enables the constant feedback and update of information within the various functional groups, by centrally managing the information shared by the various functional groups.

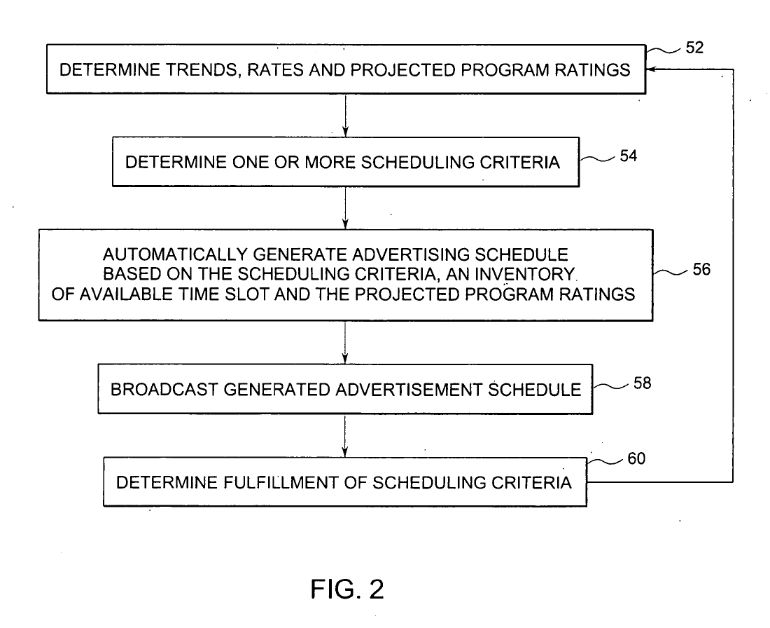

FIG. 2 is a flowchart of exemplary logic including steps for automatically generating an advertisement schedule 44 in accordance with embodiments of the invention. As shown in FIG. 2, in step 52, viewing trends 38, advertising rates 40 and projected ratings 42 for programming content to be aired are determined. As mentioned above, the viewing trends 38 are determined based on the number of audience members having one or more desired demographic attributes that have watched each airing of a particular show associated with the aired programming content over a period of time. The advertising rate 40 is the rate specified by an advertiser for a set of advertising slots over a specified duration of time and the projected ratings 42 for a show are determined based on the number of audience members having one or more desired demographic attributes that are expected to watch each airing of a particular show during a broadcast period.

In step 54, one or more scheduling criteria 48, such as contract terms, for one or more advertisements to be scheduled are determined based on the viewing trends 38, the advertising rate 40 and the projected ratings 42. As mentioned above, the scheduling criteria 48 may include a set of advertising slots requested by an advertiser at a specified rate over a specified duration of time and are generated based on a desired number of audience members having one or more desired demographic attributes.

In step 56, the advertising schedule 44 is automatically generated based on the scheduling criteria 48, an inventory of available advertising slots 46 and the projected ratings 42. As mentioned above, the inventory of available advertising slots is on one or more broadcast networks and/or broadcast mediums.

In step 58, the generated advertisement schedule is broadcast in conjunction with the program schedule. In one embodiment, a plurality of advertising schedules for a plurality of broadcast networks is generated and broadcast.

In step 60, the actual program ratings 36 are compared with the scheduling criteria 48, such as contract terms, to determine if the criteria have been met. This information may be used to optimize the fulfillment of the scheduling criteria and maximize the revenue generated. As mentioned above, a feedback process enables the constant update of information, as new information becomes available to the various functional groups, such as research, sales, traffic, on-air and accounting within the broadcast process. For example, in the depicted logic, determination of contract fulfillment at step 60 may in turn be used in subsequent iterations to determine upstream criteria such as advertising rates and/or other upstream criteria that contribute to subsequent contracts and, thereby, to subsequent schedules.

Embodiments of the invention offer several advantages including the ability to monitor the various function driven processes that comprise the generation of the advertising schedule and integrate and/or centralize the data and information from each function. Further, information from any stage of the broadcast process may be accessible by any of the other function driven processes, such as sales, research, traffic, on-air and accounting. The integration of the information from the different stages of the broadcast process improves the sales and contract generation process and improves placement of inventory within the broadcast schedule. In addition, the system disclosed in accordance with embodiments of the present invention, is capable of scheduling advertisements across multiple broadcast networks and multiple broadcast mediums in embodiments where the functional information for the relevant networks and/or media is integrated for the different functional groups, as discussed herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for generating an advertising schedule, the method comprising:
automatically generating an advertisement schedule based on an inventory of available advertising slots characterized by a projected audience and one or more scheduling criteria for each advertisement to be scheduled.

2. The method of claim 1, wherein the inventory of available advertising slots is on one or more broadcast networks.

3. The method of claim 1, wherein the inventory of available advertising slots is on one or more broadcast mediums.

4. The method of claim 1, wherein the projected audience comprises at least one of television viewers, radios listeners, and Internet users.

5. The method of claim 1, wherein the one or more scheduling criteria is generated based on a desired number of audience members having one or more desired demographic attributes.

6. The method of claim 1 further comprising determining at least one of a viewing trend, an advertising rate, or projected ratings for aired programming content that comprises the advertisement schedule.

7. The method of claim 6, comprising determining the scheduling criteria based on one or more of the viewing trends, advertising rate, or projected ratings.

8. The method of claim 7, comprising automatically generating the advertising schedule based on at least one of the scheduling criteria, the inventory of available advertising slots or the projected ratings.

9. The method of claim 8, comprising comparing a set of actual program ratings with the scheduling criteria.

10. The method of claim 9, further comprising optimizing the fulfillment of the scheduling criteria and maximizing the revenue generated based on the comparison.

11. The method of claim 1, further comprising broadcasting the generated advertisement schedule in conjunction with the program schedule.

12. The method of claim 1, further comprising generating and broadcasting a plurality of advertising schedules to a plurality of broadcast networks.

13. A system for generating an advertising schedule, the system comprising:
a data source;
one or more computers connected to the data source, wherein the one or more computers are configured to execute one or more applications related to the generation of an advertising schedule; and
a network connecting the one or more computers and the data source, wherein the one or more applications executed on the one or more computers interact with the data source to automatically generate the advertising schedule based on an inventory of available advertising slots characterized by a projected audience and one or more scheduling criteria for each advertisement to be scheduled.

14. The system of claim 13, wherein the one or more computers comprise one or more workstations, servers, or mainframes.

15. The system of claim 13, wherein the inventory of available advertising slots is on one or more broadcast networks.

16. The system of claim 13, wherein the inventory of available advertising slots is on one or more broadcast mediums.

17. The system of claim 13, wherein the projected audience comprises at least one of television viewers, radios listeners, and Internet users.

18. The system of claim 13, wherein the scheduling criteria are generated based on a desired number of audience members having one or more desired demographic attributes.

19. The system of claim 13, wherein the one or more applications determine at least one of a viewing trend, advertising rate or projected ratings for aired programming content that comprises the advertisement schedule.

20. The system of claim 19, wherein the one or more applications are configured to determine the scheduling criteria based on one or more of the viewing trends, the advertising rate or the projected ratings.

21. The system of claim 20, wherein the one or more applications automatically generate the advertising schedule based on at least one of the scheduling criteria, the inventory of available advertising slots or the projected ratings.

22. The system of claim 21, wherein the one or more applications comprise comparing a set of actual program ratings with the scheduling criteria.

23. The system of claim 22, further comprising optimizing the fulfillment of the scheduling criteria and maximizing the revenue generated based on the comparison.

24. The system of claim 21, further comprising broadcasting the generated advertisement schedule in conjunction with the program schedule.

25. The system of claim 21, further comprising generating and broadcasting a plurality of advertising schedules to a plurality of broadcast networks.

26. A method for generating an advertising schedule, the method comprising:
determining at least one of a viewing trend, an advertising rate or projected ratings for programming content to be aired;
determining one or more scheduling criteria for one or more advertisements to be scheduled based on the viewing trend, the advertising rate or the projected ratings; and
automatically generating an advertising schedule based on at least one of the one or more scheduling criteria, an inventory of available advertising slots or the projected ratings.

27. The method of claim 26, further comprising comparing a set of actual program ratings with the scheduling criteria.

28. The method of claim 26 comprising broadcasting the generated advertisement schedule in conjunction with the program schedule.

29. The method of claim 26 further comprising generating and broadcasting a plurality of advertising schedules to a plurality of broadcast networks.

30. A computer readable media, comprising:
routines adapted to generate an advertisement schedule based on an inventory of available advertising slots characterized by a projected audience and one or more scheduling criteria for each advertisement to be scheduled.

31. A computer readable media, comprising:
routines adapted to determine at least one of a viewing trend, an advertising rate or projected ratings for programming content to be aired;
routines adapted to determine one or more scheduling criteria for each advertisement to be scheduled based on the viewing trend, the advertising rate or the projected ratings; and
routines adapted to automatically generate the advertising schedule based on at least one of the one or more scheduling criteria, an inventory of available advertising slots or the projected ratings.
